(19) United States
(12) Patent Application Publication
(10) Pub. No.: US 2010/0328708 A1
(43) Pub. Date: Dec. 30, 2010

(54) PRINTING METHOD AND SYSTEM FOR CALCULATING FILE PRINTING TIME

(75) Inventors: Chun-Keong Chew, Tu-Cheng (TW); Hou-Yi Yang, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/558,316

(22) Filed: Sep. 11, 2009

(30) Foreign Application Priority Data
Jun. 24, 2009 (CN) 200910303587.2

(51) Int. Cl. G06F 3/12

(52) U.S. Cl. 358/1.15

(57) ABSTRACT

A printing method for calculating printing time of printing a file is provided. The printing method includes following steps. Obtaining the file size, page count of the file, and a plurality of printing parameters stored in a BIOS chip. Calculating an actual printing time and a waiting time between pages of the file according to the file size and pages, and the printing parameters. The sum printing time is displayed. Also, a printing system is provided in present disclosure.

### BACKGROUND

1. Technical Field

The present disclosure relates to printing methods and systems, and particularly, to a printing method and system for calculating file printing time.

2. Description of Related Art

In use, a printer is typically connected to a client, such as a computer. The computer sends a file to the printer for printing on command. Generally, users don't know how long it will take to print the file. When the printer receives a printing command from the computer and starts to print the file, users must wait to fetch the printed document. If the print procedure takes a long time, users will waste time waiting for the file to print.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an embodiment of a printing system for calculating file printing time.

FIG. 2 is a flow chart of a printing method for calculating file printing time by using the printing system of FIG. 1.

### DETAILED DESCRIPTION

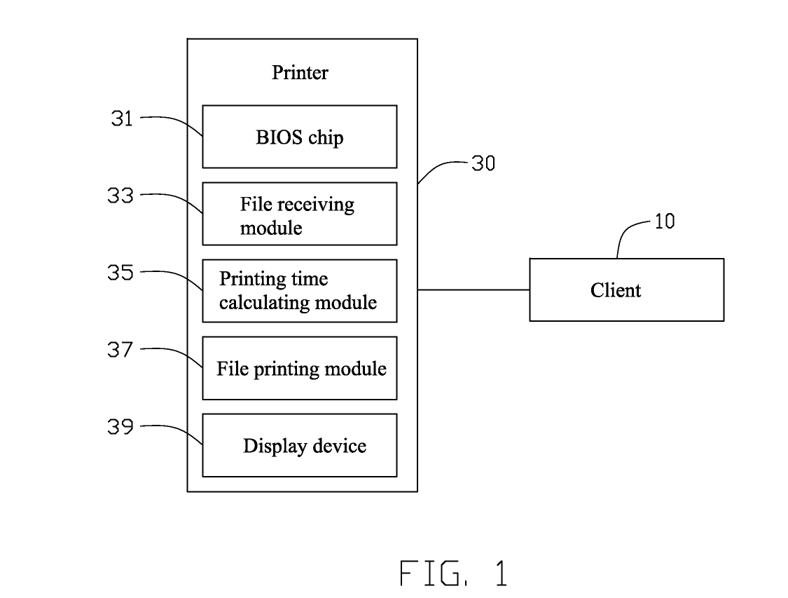

Referring to FIG. 1, an embodiment of a printing system includes a client 10 and a printer 30 connected to the client 10. The client 10 may be a desktop computer, notebook, personal digital assistant, or mobile phone, for example.

The printer 30 includes a Basic Input/Output System (BIOS) chip 31, a file receiving module 33, a printing time calculating module 35, a file printing module 37 configured to cause the printer 30 to print files, and a display device 39 configured to show the required printing time for printing the file. A plurality of printing parameters is stored in the BIOS chip 31. The printing parameters include a printing speed S of the printer 30, and a time period t0 between ending printing one page and starting printing a next page. The file receiving module 33 is configured to receive files from the client 10 and getting a file size B and page count P. The printing time calculating module 35 is configured to read the file size B and page count P and calculate the required printing time according to the printer parameters, the file size B and the number of pages P.

The printing time T for printing a file is equal to an actual printing time t1 for printing the determined file plus a waiting time t2 between pages of the file to be printed. That is, T=t1+t2. The actual printing time t1 is determined by the printer printing speed S and the file size B. That is, t1=B/S. The waiting time t2 is, t2=(P−1)*t0. Therefore, the total printing time T for printing a file can be calculated as: T=B/S+(P−1)*t0. During printing of the file, the printing time calculating module 35 will continue to calculate the printing time for printing remaining pages of the file.

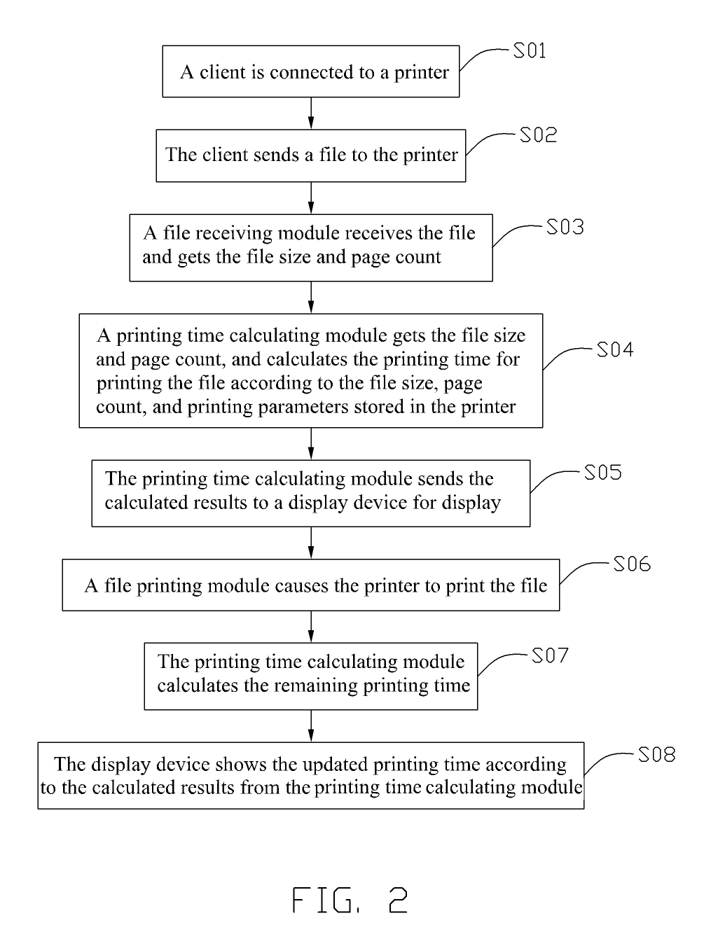

Referring to FIG. 2, a print method for calculating file printing time is described below.

Step S01: The client 10 is connected to the printer 30.

Step S02: the client 10 sends a file to the printer 30.

Step S03: the file receiving module 33 of the printer 30 receives the file and gets the file size and page count.

Step S04: the printing time calculating module 35 reads the file size and page count from the file receiving module 33, and calculates the printing time for printing the file according to the file size, page count, and the printing parameters stored in the BIOS chip 31 of the printer 30.

Step S05: the printing time calculating module 35 sends the calculated results to the display device 39 for display.

Step S06: the file printing module 37 causes the printer to print the file.

Step S07: the print time calculating module 35 calculates the remaining printing time as each page is printed.

Step S08: the display device 37 shows the updated printing time according to the calculated results from the calculating module 35.

When printing a file by the above described print system and method, users can be informed of the required printing time for printing a file from the display device 37 of the printer 30 or it can be sent to the client 10.

It is to be understood, however, that even though numerous characteristics and advantages of the embodiments have been set forth in the foregoing description, together with details of the structure and function of the present disclosure, the disclosure is illustrative only, and changes may be made in detail, especially in matters of shape, size, and arrangement of parts within the principles of the embodiments to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A printing method for calculating printing time, comprising:
receiving a file to be printed;
obtaining the file size, page count of the file, and a plurality of printing parameters stored in a BIOS chip;
calculating a sum printing time which comprises actual printing time of printing pages in file plus waiting time between pages of the file; and
displaying the sum printing time.

2. The printing method of claim 1, wherein the printing parameters comprises a printing speed of the printer; and the actual printing time is equal to the file size divided by the printer printing speed.

3. The printing method of claim 2, wherein the printing parameters further comprises a time period between ending printing of one page and starting printing of a next page, and the waiting time during printing the file is equal to the page count subtracting one and then multiplying by the time period.

4. The printing method of claim 1, further comprising printing the file according to a print command.

5. The printing method of claim 4, further comprising recalculating a remaining printing time during printing.

6. The printing method of claim 5, further comprising displaying the remaining printing time on a display device.

7. A printing system, comprising:
a printer, the printer comprising:
a file receiving module configured to receive a file sent to the printer;
a file printing module configured to cause the printer to print the file;
a BIOS chip storing printing parameters;
a printing time calculating module configured to obtain the file size and page count, and calculate a sum printing time for printing the file according to the printing parameters, file size and page count; and
a displaying device configured to show the printing time.

8. The printing system of claim 7, wherein the printing parameters comprises of a printing speed of the printer, and a time period between ending printing one page and starting printing a next page.

9. The printing system of claim 8, wherein the printing time is equal to an actual printing time of printing the file plus a waiting time between pages of the file.

10. The printing system of claim 9, wherein the actual printing time is equal to the file size divided by the printer printing speed.

11. The printing system of claim 9, wherein the waiting time during printing the file is equal to the page count subtracting one and then multiplying the time period.
